(19) United States
(12) Patent Application Publication
(10) Pub. No.: US 2026/0097414 A1
(43) Pub. Date: Apr. 9, 2026

(54) CONTAINER FOR EFFICIENT COATING OF OBJECTS

(71) Applicant: Michael Lewis Sinclair, Aurora, CO (US)

(72) Inventor: Michael Lewis Sinclair, Aurora, CO (US)

(73) Assignee: Total Dip LLC, Aurora, CO (US)

(21) Appl. No.: 18/908,064

(22) Filed: Oct. 7, 2024

(51) Int. Cl. B05C 3/02; B65D 1/34; B65D 21/02; B65D 25/56

(52) U.S. Cl. CPC B05C 3/02; B65D 1/34; B65D 21/0233; B65D 25/56; B65D 2203/04

(57) ABSTRACT

The present disclosure provides a container for holding a dipping substance. The container includes a center portion defining a volume for holding the dipping substance, one or more slot portions extending from the center portion, each slot portion defining a volume for holding the dipping substance, and a displacement portion above the center portion and the one or more slot portions. The displacement portion is configured to receive displaced dipping substance when an object is inserted into the center portion or one of the one or more slot portions. The container may include a lip configured to interact with a lid, and inner walls with a draft angle to allow for stacking of multiple containers. The container is designed to efficiently coat objects with the dipping substance while minimizing waste.

### FIELD OF INVENTION

The present disclosure relates to containers for holding dipping substances, and more particularly to a container with slots designed for efficient food dipping using displacement and slot surfaces to optimize coating of objects such as food items.

### BACKGROUND

Dipping sauces and condiments are popular accompaniments to a wide variety of foods, particularly appetizers, snacks, and finger foods. These dipping substances enhance the flavor and enjoyment of foods such as chicken wings, vegetables, chips, and other bite-sized items. Traditional containers for dipping sauces, such as small bowls or ramekins, often require a relatively large volume of sauce to provide adequate coverage.

The design of dipping containers can significantly impact the user experience, food enjoyment, and even the amount of sauce consumed or wasted. Conventional containers may not efficiently coat food items, leading to uneven distribution of sauce or excessive use to achieve desired coverage. This can result in wasted sauce, potentially messy eating experiences, and less than optimal coating of the dipping substance.

In food service environments, such as restaurants or catering events, the efficiency of dipping containers becomes even more critical. Servers and kitchen staff need to quickly and easily prepare and distribute dipping sauces, while customers expect a convenient and mess-free dining experience. The stackability and storage efficiency of dipping containers are also important considerations for food service operations with limited space.

Environmental concerns have led to increased scrutiny of single-use food packaging and containers. There is a growing demand for more sustainable options that minimize waste while still providing the functionality and convenience expected by consumers. This has prompted exploration of various materials and designs that can balance performance, cost-effectiveness, and environmental impact.

The viscosity and consistency of different dipping sauces can vary widely, from thin, watery sauces to thick, creamy dressings. Dipping containers need to accommodate this range of consistencies while still facilitating easy and effective food coating. Additionally, the ability to maintain the temperature of hot or cold sauces for an extended period can enhance the overall dining experience.

As the food service industry continues to evolve, there is an ongoing need for innovative solutions that can improve the dipping experience for consumers while addressing the operational needs of food service providers. Advancements in container design have the potential to impact food enjoyment, operational efficiency, and sustainability in the food service sector.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a container for holding a dipping substance is provided. The container includes a center portion defining a volume for holding the dipping substance, one or more slot portions extending from the center portion, each slot portion defining a volume for holding the dipping substance, and a displacement portion above the center portion and the one or more slot portions. The displacement portion is configured to receive displaced dipping substance when an object is inserted into the center portion or one of the one or more slot portions.

According to other aspects of the present disclosure, the container may include one or more of the following features. The container may include a lip configured to interact with a lid. Container and it's portions may comprise a draft angle to allow for stacking of multiple containers. The inner walls of the center portion and the one or more slot portions act to allow the dipping substance to coat an object inserted into the container. The container may be shaped like a football when viewed from above to provide a larger displacement portion and also for aesthetics for use at football watching events. The container may be configured to hold approximately 1 fluid ounce of dipping substance in the center portion and the one or more slot portions. The displacement portion may be configured to hold approximately 0.5 fluid ounces of displaced dipping substance. The container may include one or more volume indicators. The container may be made of a disposable material. The container may be made of a durable, reusable material. The container may include fillets between the center portion and the one or more slot portions.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an isometric view of a container for holding dipping substances, according to aspects of the present disclosure.

FIG. 2 depicts top and sectional views of the container of FIG. 1, according to an embodiment.

FIG. 3 shows top and cross-sectional views of the container with dimensional indicators, in accordance with example embodiments.

FIG. 4 illustrates cutaway views of the container in unused and in-use states, according to aspects of the present disclosure.

FIG. 5 depicts a cutaway view of stacked containers, according to an embodiment.

FIG. 6 shows various views of the container with various lid configurations, in accordance with example embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a container designed for holding and dispensing dipping substances, such as sauces, for food items. The container is characterized by a unique design that includes a center portion, having a first shape such as essential a cylinder or cone, and one or more slot portions extending from the center portion, having a second shape with a smaller cross section such as an extruded slot or oval. The first shape having a cross section larger than the second shape prevents the container from tipping when in use. These portions are designed to hold the dipping substance and allow for efficient dipping of differently shaped food items. The container also includes a displacement portion located above the center and slot portions. This displacement portion is configured to receive displaced dipping substance when a food item is inserted into the center portion or one of the slot portions, thereby preventing spills and optimizing the use of the dipping substance.

In some embodiments, the container may include a lip configured to interact with a lid, providing a means to cover and protect the dipping substance when not in use. The container may be designed to hold a specific volume of dipping substance in the center and one or more slot poritions, specifically 1 to 2 ounces, and may include one or more volume indicators to assist in filling the container to the desired level.

The container may be designed with a shape that resembles a football when viewed from above, providing both aesthetic appeal and a functional benefit of a larger volume for it's height relative to the smaller cross sections of the center and slot portions. The container may also be designed to be stackable, facilitating efficient storage and transportation.

The container may be made from various materials, including disposable options such as plastics or biopolymers, or durable options such as glass or metal, depending on the intended use and desired characteristics. The container's design and features contribute to an improved dipping experience, operational efficiency, and sustainability in food service and other applications.

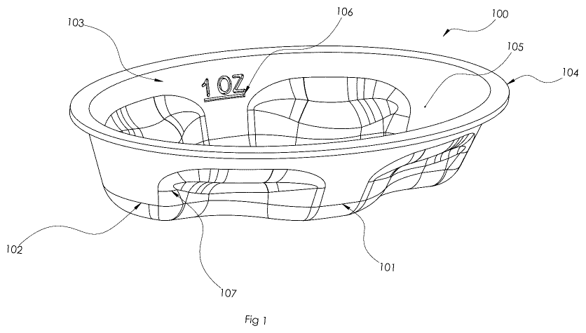

Referring to FIG. 1, the figure illustrates an isometric view of a container 100 designed for holding dipping substances. The container 100 comprises several components, including a center portion 101, slot portions 102, a displacement portion 103, and a lip 104. The center portion 101 forms the main body of the container 100 and is predominantly cylindrically shaped, while the slot portions 102 extend outward from the center portion 101 and are predominantly extruded slots or extruded ovals in shape, creating areas for dipping objects. The displacement portion 103 is positioned above the center portion 101 and slot portions 102, providing additional volume for dipping substance that is displaced when the dipping object is inserted into the container.

The container 100 features inner walls 105 that define the shape of the center portion 101, slot portions 102, and the displacement portion 103 that make contact with the dipping substance. A volume indicator 106 is visible on the inner wall 105, allowing users to measure the amount of dipping substance in the container 100. Fillet radii 107 are incorporated at the junctions between the center portion 101, slot portions 102, and displacement portion to allow for smooth transitions, thus allowing the dipping substance to flow around the container.

The lip 104 extends around the upper edge of the container 100, providing a surface for attaching lids or for ease of handling. The overall shape of the container 100 resembles a football when viewed from above, with the slot portions 102 forming elongated ends. This design allows for efficient dipping of various food items while minimizing the amount of dipping substance required, specifically catering to oblong shaped chicken wings and drumsticks.

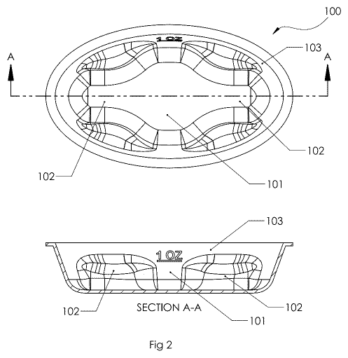

Referring to FIG. 2, the figure illustrates a top view and a sectional view of the container 100. The top view shows the overall shape of the container 100, which has an elongated oval form. The center portion 101 is located in the middle of the container 100 and is surrounded by one or more slot portions 102 on opposite sides. The displacement portion 103 forms the outer perimeter of the container 100.

The sectional view, labeled as SECTION A-A, provides a cross-sectional view of the container 100. This view clearly shows the relationship between the center portion 101, slot portions 102, and displacement portion 103. The displacement portion 103 is illustrated as the uppermost part of the container 100, extending above the center portion 101 and slot portions 102.

The container 100 is designed with smooth transitions between its different portions. The slot portions 102 curve upwards to meet the displacement portion 103, creating a continuous surface. This design allows for efficient use of the container's volume and facilitates the movement of dipping substances within the container 100.

In some cases, the container 100 can have one or more slot portions 102 extending from the center portion 101. These slot portions 102 can have different shapes and sizes depending on the dipped object. For example, for larger food items, the slot portions 102 may be wider and deeper, while for smaller food items, the slot portions 102 may be narrower and shallower. This flexibility in the design of the slot portions 102 allows the container 100 to accommodate a wide range of food items, enhancing its versatility and usability.

In some embodiments, the slot portions may have textured surfaces to enhance the adherence of the dipping substance to the food item. This texturing may include small ridges, dimples, or other patterns that increase surface area and promote better coating of the dipped object.

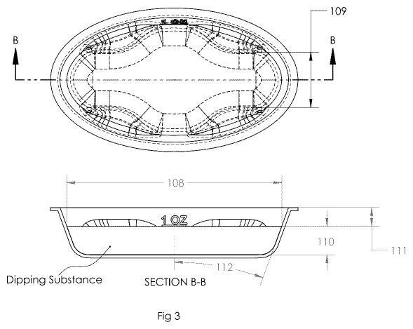

Referring to FIG. 3, the figure illustrates key dimensions and features of the container 100 as shown in the top and cross-sectional views. The top view shows the overall shape of the container 100, which has an elongated oval form. The slot length 108 is indicated, spanning the full length of the center and slot portions. The slot width 109 is shown as width of the slot.

In some aspects, the ideal slot dimensions may be tailored to optimize the dipping experience for a variety of food items. The slot width 109 may range from approximately 0.5 inches to 1.5 inches, allowing for comfortable insertion of common dipping foods such as chicken wings, carrot sticks, or celery stalks. This width range may accommodate various food sizes while minimizing excess dipping substance displacement.

The slot length 108 may extend from approximately 3 inches to 5 inches, providing ample space for longer food items like chicken strips. This length may allow for efficient dipping of most standard-sized appetizers and snacks.

The slot height 110 is essentially the height of the area which holds the dipping substance when filled with sauce and may vary from about 0.5 inches to 1 inches, depending on the overall container size and desired dipping substance volume. This depth range may provide sufficient coverage for most food items while maintaining an appropriate ratio of dipping substance to displacement volume.

The transition between the slot portions and the center portion may incorporate fillet radii ranging from 0.125 inches to 0.5 inches. These rounded edges may facilitate smooth movement of the dipping substance and ease cleaning of the container.

The cross-sectional view, labeled as SECTION B-B, provides details of the container's internal structure. The slot height 110 is depicted. Additionally a displacement height 111 is indicated, which represents an upper portion of the container 100 configured to hold displaced dipping substance.

The cross-section also reveals the draft angle 112, which shows how the sides of the container 100 are angled inward. This angled design facilitates stacking of multiple containers 100, as well as efficient use of the container's volume for holding dipping substances.

Inside the container 100, a volume of dipping substance 113 is illustrated, filling the center and slot portions. A volume indicator 106 is visible on the inner surface, allowing users to measure the amount of dipping substance in the container 100. In some cases, the container 100 can have multiple volume indicators 106 to aid in filling to specific volumes. These volume indicators 106 can be words, numbers, arrows, lines, or other visual markers that indicate the desired fill level.

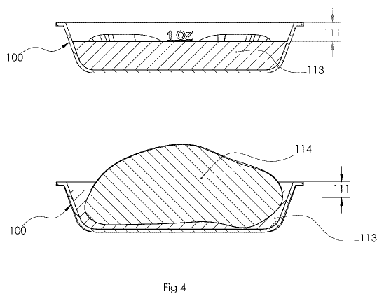

Referring to FIG. 4, the figure illustrates cutaway views of the container 100 in two states: unused and with a dipped object 114 inserted. In the unused state, the container 100 is filled with a dipping substance 113 up to a level below the displacement portion 103. The displacement height 111 is indicated to show the displacement portion 103 more clearly. This space is designed to accommodate the displaced dipping substance 113 when a food item is inserted into the container 100, thereby preventing overflow and optimizing the use of the dipping substance 113.

In the state with the dipped object 114 inserted, the dipped object 114 displaces the dipping substance 113, causing it to rise within the container 100. The displacement height 111 is shown, indicating the space that accommodates the displaced dipping substance 113 without overflow. This design feature allows for efficient use of the dipping substance 113, which allows the the dipped object to be coated more thoroughly and reduces waste which enhancing the dipping experience.

In some cases, the container 100 may be designed with a larger displacement height 111 to accommodate larger food items or larger volumes of dipping substance 113. In other cases, the container 100 may be designed with a smaller displacement height 111 for smaller food items or smaller volumes of dipping substance 113. The specific dimensions of the displacement height 111 can be adjusted based on the intended use of the container 100 and the specific characteristics of the dipping substance 113 and the food items to be dipped.

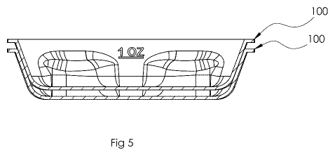

Referring to FIG. 5, the figure illustrates a cutaway view of a stacked configuration of containers 100. The containers 100 are designed to nest efficiently for storage and transportation. The walls of the containers 100 are angled to facilitate nesting, with the upper container fitting snugly into the lower container. This stacked arrangement demonstrates how multiple containers 100 can be compactly stored, optimizing space utilization. The design of the containers 100 allows for a close fit between stacked units while preserving the integrity of each individual container's structure and slot portions 102.

In some cases, the containers 100 may be designed with different dimensions or shapes to accommodate different types of food items or dipping substances. For example, the containers 100 may be designed with wider or narrower center and slot portions 102, or deeper or shallower center portions 101, depending on the size and shape of the food items to be dipped and the viscosity of the dipping substance. Despite these variations, the containers 100 are designed to maintain their stackability, ensuring efficient storage and transportation regardless of the specific design parameters.

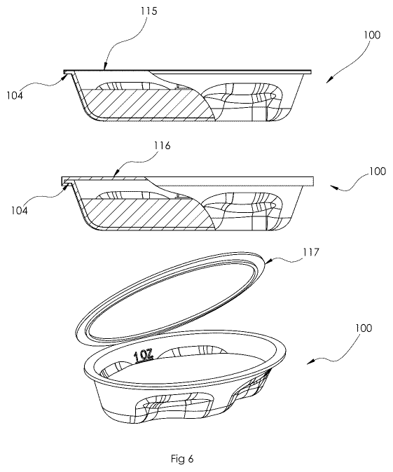

Referring to FIG. 6, the figure illustrates three orthogonal views of a container 100 with different lid configurations. The lid is an optional feature of the container.

The top view shows the container 100 with a disposable lid 115. The disposable lid 115 is depicted as a thin layer that covers the entire top opening of the container 100, attaching to the lip 104. In some cases, the disposable lid 115 may be made of a material such as foil, wax paper, or thin plastic, and may be attached to the lip 104 using an adhesive. This configuration may be particularly suitable for one-time use of the container 100, after which the lid 115 and the container 100 can be discarded.

The middle view presents the container 100 with a reusable lid 116. The reusable lid 116 is shown as a more substantial structure compared to the disposable lid 115, and it also attaches to the lip 104 of the container 100. In some aspects, the reusable lid 116 may be made of a durable and flexible material, such as silicone, that can stretch around the lip 104 to form a seal. This configuration allows the lid 116 to be removed and reattached multiple times, making the container 100 suitable for repeated use.

The bottom view displays the container 100 with a hinged lid 117. The hinged lid 117 is connected to the container 100 at one end, allowing it to pivot open and closed. This configuration keeps the lid 117 permanently attached to the container 100, preventing it from being lost and making it easy to access the dipping substance in the container 100. In some cases, the hinged lid 117 may be formed integrally with the container 100, such as in a single molding process.

Each lid option (115, 116, 117) is designed to cover the slot portion 102 and the rest of the container's opening. The slot portion 102 is visible in the bottom view, showing its integration into the overall design of the container 100. The lid configurations provide options for both disposable and reusable versions of the container 100, catering to different use scenarios and user preferences.

In some cases, the container 100 may be made from various materials, depending on the intended use and desired characteristics. For instance, for a disposable, one-time use version of the container 100, materials such as plastics or biopolymers may be used. These materials are typically lightweight, inexpensive, and can be easily molded into the desired shape of the container 100. In some aspects, the plastic or biopolymer material may be food-safe and may be selected for its ability to hold dipping substances without reacting with them or altering their taste.

In other cases, for a more durable, reusable version of the container 100, materials such as glass or metal may be used. These materials are typically more robust and can withstand repeated use and cleaning. For instance, a glass container 100 may be transparent, allowing users to see the amount of dipping substance remaining in the container. A metal container 100, on the other hand, may be more durable and resistant to breakage.

In some embodiments, the container 100 may incorporate materials with thermal properties to help maintain the optimal temperature of the dipping substance. For instance, the container 100 could be made from a material with low thermal conductivity, such as certain plastics or ceramics, to help keep the dipping substances cool or hot. Alternatively, the container 100 could be made from a material with high thermal conductivity, such as metal, to help bring the dipping substance to ambient temperature more quickly.

In some cases, the container 100 may have adjustable or modular components that allow users to customize the volume of the dipping substance. For instance, the container 100 could include removable inserts or a sliding mechanism that alters the internal capacity of the container. This feature would allow users to adjust the amount of dipping substance in the container 100 to suit their personal preferences or the size of the food items being dipped.

In some aspects, the container 100 may be designed with additional features to enhance its functionality and user experience. For instance, the container 100 could include a handle or grip for easy handling, a lid with a built-in applicator for spreading the dipping substance, or a base with a non-slip surface for stability. These and other design variations can be implemented to optimize the functionality and usability of the container 100, further enhancing its utility in food service and other applications.

In some cases, the container 100 may be manufactured using various methods depending on the chosen material and the desired characteristics of the final product. For instance, if the container 100 is made from a plastic or biopolymer material, it may be produced using a vacuum forming process. This process involves heating a plastic sheet until it becomes pliable, then shaping it into the desired form using a mold and a vacuum to draw the material into the mold. This method is typically cost-effective and suitable for producing large quantities of the container 100.

Alternatively, if the container 100 is made from a metal material, it may be produced using a stamping process. This process involves using a die to shape the metal into the desired form. This method is typically more robust and suitable for producing a durable, reusable version of the container 100. If the container 100 is made from a glass material, it may be produced using a casting process. This process involves pouring molten glass into a mold and allowing it to cool and solidify. This method is typically suitable for producing a transparent, reusable version of the container 100.

In some aspects, the slot surfaces of the container 100 may have different textures or patterns to improve the adhesion of the dipping substance 113. For instance, the slot surfaces may include small ridges, dimples, or a honeycomb pattern that increases surface area and promotes capillary action, potentially improving the coating of food items even further.

In addition to its primary use for dipping food items, the container 100 may be adapted for use in various other applications. For instance, in an automotive paint application, the container 100 could be used to hold and dispense paint onto a different kind of object such as a paint brush. The slot surfaces would aid in coating test strips or slides evenly, while the displacement portion would provide a safety buffer against spills of potentially hazardous materials.

In a culinary sauce sampling application, the container 100 could be used in high-end restaurants or food festivals for sauce tasting events. The small, controlled portions are ideal for sampling a variety of sauces without overwhelming diners. The slot surfaces would allow for optimal coating of tasting spoons or small food items, enhancing the tasting experience.

In a laboratory chemical dispensing application, the container 100 could be used for precise dispensing of small volumes of chemicals or reagents. The slot surfaces would aid in coating test strips or slides evenly, while the displacement portion would provide a safety buffer against spills of potentially hazardous materials.

A number of implementations have been described. Nevertheless, it will be understood that various modifications may be made without departing from the spirit and scope of the disclosure. Accordingly, other implementations are within the scope of the following claims.

1. A container for holding a dipping substance, comprising:
a center portion of a first shape;
one or more slot portions extending from the center portion having a second shape, each slot portion defining a volume for holding the dipping substance; and
a displacement portion above the center portion and the one or more slot portions, configured to receive displaced dipping substance when an object is inserted into the center portion or one of the one or more slot portions.

2. The container of claim 1, where the first shape circular or conical and the second shape is an extruded slot or extruded oval.

3. The container of claim 1, further comprising a lip configured to interact with a lid.

4. The container of claim 1, wherein one or more portions define a draft angle to allow for stacking of multiple containers.

5. The container of claim 1, further comprising one or more volume indicators.

6. The container of claim 1, further comprising fillets between the center portion and the one or more slot portions and the displacement portion.

7. The container of claim 1, wherein forming the center portion and the one or more slot portions includes a draft angle configured to allow for stacking of multiple containers.

8. The container of claim 1, wherein the slot portion comprises a slot width from 0.5 to 1.5 inches.

9. The container of claim 1, wherein the slot portion comprises a slot height of 0.5 to 1 inch.

10. The container of claim 1, wherein the slot portion comprises a slot length of 3 to 5 inches.

11. The container of claim 1, where the displacement portion has a larger cross section than the combined cross section of the center portion and one or more slot portions.

12. The container of claim 5, wherein the one or more volume indicators are configured to indicate a fill level of 1 to 2 ounces of dipping substance in the center portion and the one or more slot portions.
